(19) United States
(12) Patent Application Publication
(10) Pub. No.: US 2005/0019685 A1
(43) Pub. Date: Jan. 27, 2005

(54) Naphthalenetetracarboxylic diimide derivatives and electrophotographic photoconductor containing the same

(75) Inventors: Beom-jun Kim, Seononam-si (KR); Seung-ju Kim, Suwon-si (KR); Saburo Yokota, Suwon-si (KR); Kyung-yol Yon, Seongnam-si (KR); Hwan-kog Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/869,039

(22) Filed: Jun. 17, 2004

(30) Foreign Application Priority Data
Jun. 20, 2003 (KR) 2003-40080

(51) Int. Cl. G03G 5/06

(52) U.S. Cl. 430/78; 430/60; 399/117; 399/162; 399/262

(57) ABSTRACT

A naphthalenetetracarboxylic diimide derivative having formula (1) below, in which flexible ether groups are bonded to nitrogen atoms of diimide, is utilized to yield an effective solubility in organic solvents and compatibility with binder resins, thus providing an effective electron transporting ability:

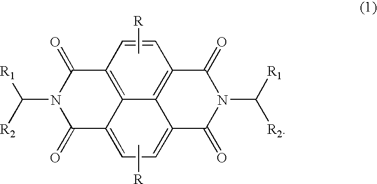

### CROSS-REFERENCE TO RELATED APPLICATIONS

This application claims the priority of Korean Patent Application No. 2003-40080, filed on Jun. 20, 2003, in the Korean Intellectual Property Office, the disclosure of which is incorporated herein in its entirety by reference.

### BACKGROUND OF THE INVENTION

1. Field of the Invention

The present invention relates to an electrophotographic photoconductor that includes a naphthalenetetracarboxylic diimide derivative, and more particularly, to an electrophotographic organophotoconductor that includes a naphthalenetetracarboxylic diimide derivative having effective solubility in organic solvents and an effective compatibility with polymer binder resins, thus providing effective electron transporting ability.

2. Description of the Related Art

Organophotoconductor (OPC) drums used in laser printers etc. are widely categorized into two types. The first is a laminated type having a double-layered structure including a charge generating layer composed of a binder resin and a charge generating material (CGM), and a charge transport layer composed of a binder resin and a charge transport material (mainly a hole transport material (HTM)). In general, the laminated type OPC drum is used in the fabrication of a negative (−) type OPC. The other type is a single layered type in which a layer is composed of a binder resin, a charge generating material, a hole transport material and an electron transport material (ETM). In general, the single layered type OPC drum is used in the fabrication of a positive (+) type OPC.

The (+) type single layered OPC is advantageous in that it generates a small amount of ozone harmful to human bodies and since it has a single photoconductive layer, its production cost is low. The most essential material among the materials composing the (+) type single layered OPC is the electron transport material. Since the hole transporting ability of the HTM is 100 times greater than the electron transporting ability of the commonly used electron transport material, the performance of the single layered OPC depends on the electron transporting ability of the ETM.

Widely known conventional ETMs includes dicyanofluorenone, diphenoquinone, and naphthoquinone derivatives.

Dicyanofluorenone and diphenoquinone have ineffective electron transporting ability. Thus, when fabricating an OPC using these materials as the ETM, the OPC has problems, such as a reduced charge potential and an increased exposure potential after long-period use. Also, naphthoquinone derivatives do not have satisfactory levels of solubility in organic solvents, compatibility with binder resins, and electron transporting ability.

The electron transporting ability of the ETM is considerably influenced by the solubility in organic solvents and the compatibility with polymer binder resins of the ETM.

It is known that naphthalenetetracarboxylic diimide derivatives having effective solubility in organic solvents exhibit better electron transporting ability than naphthoquinone derivatives. However, representative naphthalenetetracarboxylic diimide derivatives do not have satisfactory levels of solubility in organic solvents and compatibility with polymer binder resins, and thus still have an ineffective electron transporting ability.

### SUMMARY OF THE INVENTION

The present invention provides an electrophotographic photoconductor that includes naphthalenetetracarboxylic diimide derivatives having an effective solubility in organic solvents and an effective compatibility with polymer binder resins, thus providing effective electron transporting ability.

According to an aspect of the present invention, an electrophotographic photoconductor comprises an electroconductive substrate and a photoconductive layer formed thereon, the photoconductive layer comprising a naphthalenetetracarboxylic diimide derivative having formula (1) below: 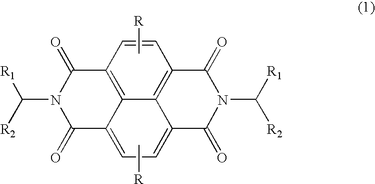
where R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; R₂ is a group having the formula —(CH₂)ₙ—O—R₃, where R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and n is an integer between 1 and 12.

According to another aspect of the present invention, an electrophotographic photoconductor comprises an electroconductive substrate, an intermediate layer formed on the electroconductive substrate, and a photoconductive layer formed on the intermediate layer, the intermediate layer comprising the naphthalenetetracarboxylic diimide derivative having formula (1) above.

According to another aspect of the present invention, an electrophotographic image forming apparatus comprises a plurality of support rollers and a photoconductor operably coupled to the support rollers with motion of the support rollers resulting in motion of the photoconductor. The apparatus may further include a dry or liquid toner dispenser.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an NMR spectrum of a naphthalenetetracarboxylic diimide derivative prepared according to Preparation Example 1 of the present invention;

FIG. 2 is an NMR spectrum of a naphthalenetetracarboxylic diimide derivative prepared according to Preparation Example 2 of the present invention;

FIG. 3 is a block diagram illustrating (not to scale) an electrophotographic photoreceptor comprising an electroconductive substrate, a photoconductive layer and an undercoat interposed between the electroconductive substrate and the photoconductive in accordance with an embodiment of the present invention; and

FIG. 4 is a schematic representation of an image forming apparatus, an electrophotgraphic drum, and an electrophographic cartridge in accordance with selected embodiments of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A naphthalenetetracarboxylic diimide derivative having formula (1) below according to an embodiment of the present invention has improved solubility in organic solvents and compatibility with binder resins, thus providing improved electron transporting ability due to a structure in which flexible ether groups are bonded to nitrogen atoms of diimide: 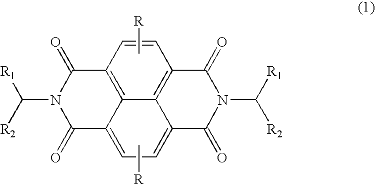
where R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; R₂ is a group having the formula —(CH₂)ₙ—O—R₃, where R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and n is an integer between 1 and 12.

In formula (1), the alkyl group is a C₁-C₂₀ linear or branched alkyl group, and preferably a C₁-C₁₂ linear or branched alkyl group. Examples of the alkyl group include methyl, ethyl, n-propyl, isopropyl, n-butyl, isobutyl, sec-butyl, tert-butyl, pentyl, hexyl, 1,2-dimethyl-propyl, 2-ethyl-hexyl, and the like.

The alkyl group may be a substituted or unsubstituted alkyl group and may be substituted with a halogen atom, for example, fluorine, chlorine, bromine or iodine.

In formula (1), the aryl group is a C₆-C₃₀ aromatic ring. Examples of the aryl group include phenyl, tolyl, xylyl, biphenyl, o-terphenyl, naphtyl, anthryl, phenanthryl, and the like. The aryl group may be a substituted or unsubstituted aryl group and may be substituted with an alkyl group, an alkoxy group, a nitro group or a halogen atom.

Examples of the naphthalenetetracarboxylic diimide derivative having formula (1) include:

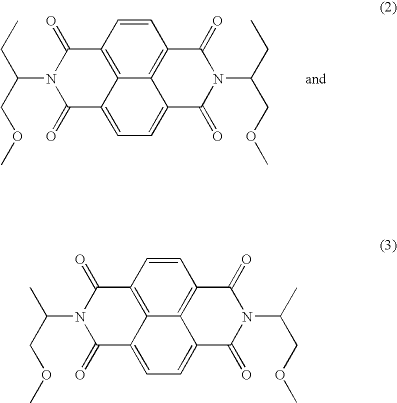

The naphthalenetetracarboxylic diimide derivative of the present invention is prepared by reacting a naphthalenetetracarboxylic acid anhydride having formula (4) with a secondary amine having formula (5) below:

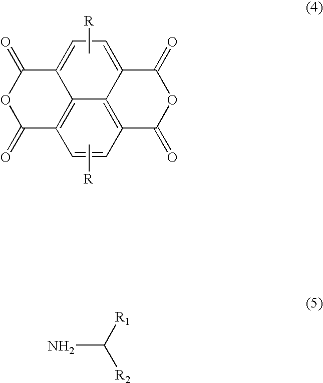

In this reaction, an organic solvent, for example, dimethylformamide, dimethylacetamide, HMPA, or NMP, may be used. The reaction temperature may be set in the range of 20° C. lower than the boiling point of the solvent to the boiling point of the solvent, and preferably, in the range of 10° C. lower than the boiling point of the solvent to the boiling point of the solvent.

The reaction may be carried out using the secondary amine in a amount greater than the stoichiometric amount with respect to the naphthalenetetracarboxylic anhydride.

In general, the naphthalenetetracarboxylic anhydride is dissolved in a solvent, for example, dimethylformamide, dimethylacetamide, HMPA, or NMP, and then the secondary amine is added drop by drop to the resulting solution. Then, the mixture is heated to the boiling point of the solvent and refluxed for 3 to 10 hours to obtain the naphthalenetetracarboxylic diimide derivative.

An electrophotographic organophotoconductor comprising the naphthalenetetracarboxylic diimide derivative having formula (1) will now be decribed in detail.

In general, a photoconductor in which a photoconductive layer is coated on an electroconductive substrate is used as the electrophotographic photoconductor. A drum- or belt-shaped substrate composed of, for example, a metal or plastic, is used as the electroconductive substrate.

The photoconductive layer is widely categorized into a laminated type and a single layered type. The laminated type photoconductive layer includes a charge generating layer that includes a charge generating material, and a charge transport layer that includes a charge transport material. Meanwhile, the single layered type photoconductive layer includes both the charge generating material and the charge transport material in one layer.

The naphthalenetetracarboxylic diimide derivative having formula (1) according to an embodiment of the present invention acts as the charge transport material, and preferably the electron transport material. In the laminated type photoconductive layer, the naphthalenetetracarboxylic diimide derivative having formula (1) is included in the charge transport layer, and in the single layered type photoconductive layer, it is clearly included in one layer together with the charge generating material.

Examples of the charge generating material used for the photoconductive layer include organic materials such as phthalocyanine pigment, azo pigment, quinone pigment, perylene pigment, indigo pigment, bisbenzoimidazole pigment, quinacridone pigment, azulenium dye, squarylium dye, pyrylium dye, triarylmethane dye, and cyanine dye, and inorganic materials such as amorphous silicon, amorphous selenium, trigonal selenium, tellurium, selenium-tellurium alloy, cadmium sulfide, antimony sulfide, and zinc sulfide. The charge generating material is not limited to the materials listed herein, and may be used alone or in a combination of two or more.

In the laminated photoconductive layer, the charge generating material is dispersed in a solvent with a binder resin, and then the dispersion is coated on the electroconductive substrate using a dip coating, a ring coating, a roll coating, or a spray coating method to form the charge generating layer. The thickness of the charge generating layer is generally in the range of 0.1 to 1.0 μm.

Examples of the binder resin for use in the charge generating layer together with the charge generating material include, but are not limited to, electrically insulating polymers, for example, polycarbonate, polyester, methacryl resin, acryl resin, polyvinyl chloride, polyvinylidene chloride, polystyrene, polyvinyl acetate, silicon resin, silicon-alkyd resin, styrene-alkyd resin, poly-N-vinylcarbazole, phenoxy resin, epoxy resin, polyvinyl butyral, polyvinyl acetal, polyvinyl formal, polysulfone, polyvinyl alcohol, ethyl cellulose, phenolic resin, polyamide, carboxy-methyl cellulose and polyurethane. These materials may be used alone or in a combination of two or more.

A charge transport layer containing the naphthalenetetracarboxylic diimide derivative having formula (1) is formed on the charge generating layer of the laminated type photoconductive layer, but the charge generating layer may be formed on the charge transport layer in reverse order. When forming the charge transport layer, the naphthalenetetracarboxylic diimide derivative having formula (1) and the binder resin are dissolved in a solvent, and the resulting solution is coated on the charge generating layer. Examples of the coating method include a dip coating, a ring coating, a roll coating, and a spray coating method, similar to the methods used to form the charge generating layer.

When preparing the single layered type photoconductor, the charge generating material is dispersed in a solvent together with the binder resin and the charge transport material, and the resulting dispersion is coated on the electroconductive substrate to obtain the photoconductive layer. In this case, the naphthalenetetracarboxylic diimide derivative having formula (1) may be used alone, but may also be used together with other charge transport material. Although the charge transport material includes a hole transport material and an electron transport material, it is preferable to use the hole transport material together with the naphthalenetetracarboxylic diimide derivative having formula (1) in the single layered type photoconductor.

Examples of the hole transport material that may be used with the naphthalenetetracarboxylic diimide derivative having formula (1) in the photoconductive layer include nitrogen containing cyclic compounds or condensed polycyclic compounds such as pyrene compounds, carbazole compounds, hydrazone compounds, oxazole compounds, oxadiazole compounds, pyrazoline compounds, arylamine compounds, arylmethane compounds, benzidine compounds, thiazole compounds or styryl compounds. Also, high molecular weight compounds or polysilane compounds having functional groups of the above compounds on a backbone or side chain may be used.

Examples of the electron transport material that may be used with the naphthalenetetracarboxylic diimide derivative having formula (1) in the photoconductive layer include, but are not limited to, electron attracting low-molecular weight compounds such as benzoquinone compounds, cyanoethylene compounds, cyanoquinodimethane compounds, fluorenone compounds, xanthone compounds, phenanthraquinone compounds, anhydrous phthalic acid compounds, thiopyrane compounds, or diphenoquinone compounds. Electron transporting polymer compounds or pigments having n-type semiconductor characteristic may also be used.

The charge transport material or the hole transport material that may be used with the naphthalenetetracarboxylic diimide derivative having formula (1) in the electrophotographic photoconductor are not limited to the materials listed herein, and the foregoing materials may be used alone or in combination of two or more.

The thickness of the photoconductive layer may be in the range of 5 to 50 μm regardless of whether the photoconductive layer is the laminated type or the single layered type.

Examples of solvents used in the formation of the photoconductive layer include organic solvents such as alcohols, ketones, amides, ethers, esters, sulfones, aromatics, aliphatic halogenated hydrocarbons, and the like. Examples of the coating method of the coating solution for forming the photoconductive layer include a dip coating, a ring coating, a roll coating, a spray coating method and the like.

The proportion of the charge transport material to the binder resin in the laminated- or the single layered-type photoconductive layer may be in the range of 1:0.5 to 1:2 parts by weight. If the proportion of the binder resin to the charge transport material is lower than the above range, the binder resin content in the photoconductive layer is lowered, thereby causing the mechanical strength to be lowered. If the proportion is higher than the above range, the electron transporting ability is insufficient, resulting in sensitivity loss and residual potential increase.

An electroconductive layer may further be formed between the electroconductive substrate and the photoconductive layer. The electroconductive layer is obtained by dispersing an electroconductive powder such as carbon black, graphite, metal powder or metal oxide powder in a solvent, and then applying the resulting dispersion on the electroconductive substrate and drying. The thickness of the electroconductive layer may be in the range of 5 to 50 μm.

Further, an intermediate layer may be interposed between the electroconductive substrate and the photoconductive layer or between the electroconductive layer and the photoconductive layer to enhance adhesion or to prevent charges from being injected from the substrate. Examples of the intermediate layer include, but are not limited to, an aluminum anodized layer; a resin-dispersed layer of metal oxide powder such as titanium oxide or tin oxide; and a resin layer such as polyvinyl alcohol, casein, ethylcellulose, gelatin, phenol resin, or polyamide. The thickness of the intermediate layer may be in the range of 0.05 to 5 μm.

Also, the photoconductive layer may contain a plasticizer, a leveling agent, a dispersion stabilizing agent, an antioxidant or a photo-stabilizing agent, in addition to the binder resin.

Examples of the antioxidant include phenol compounds, sulfur compounds, phosphorus compounds, or amine compounds. Meanwhile, examples of the photo-stabilizing agent include benzotriazole compounds, benzophenone compounds, or hindered amine compounds.

The naphthalenetetracarboxylic diimide derivative having formula (1) according to an embodiment of the present invention may be incorporated into electrophotographic image forming apparatuses such as laser printers, cathode ray tube (CRT) printers, light emitting diode (LED) printers, and liquid crystal display printers, in addition to photocopiers. In the image forming apparatuses, an image is formed from a physical embodiment, converted to a photo image, and scanned on the organophotoconductor to form a surface latent image. The surface latent image may be used to introduce a toner to the surface of the organophotoconductor to form a toned image, the toned image being the same as the photo image projected on the organophotoconductor, or a negative image. A liquid or dry toner may be used as the toner. The toned image is subsequently transferred from the surface of the organophotoconductor to a receiver surface such as a paper sheet. After transferring the toned image, the whole surface is discharged and the organophotoconductor material is prepared to be recycled. The image forming apparatus may further include, for example, a plurality of support rollers for conveying a receiver such as a sheet of paper and/or moving the organophotoconductor, an optical apparatus for forming the photo image, a light source such as a laser, a toner source, a delivery system and an appropriate control system.

The present invention will now be described in greater detail with reference to the following examples. The following examples are for illustrative purposes, and are not intended to limit the scope of the invention.

### EXAMPLES

### Preparation Example 1

### Preparation of Compound (I)

The following is a description of the preparation of the compound (I) having formula (2) below.

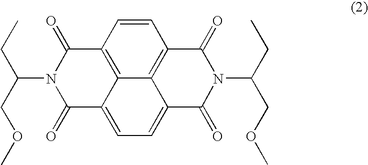

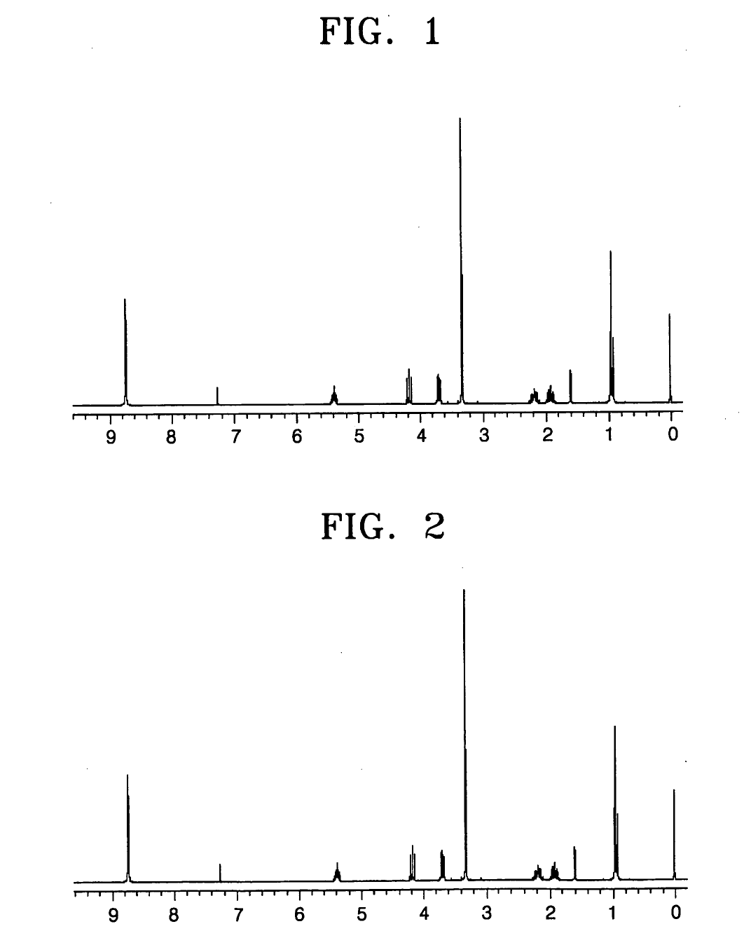

A 250 ml three neck flask equipped with a reflux condenser was purged with nitrogen, and then 10.72 g (0.04 mol) of naphthalene-1,4,5,8-tetracarboxylic acid dianhydride and 100 ml of DMF were poured thereinto and stirred at room temperature. Then, a mixture of 8.67 g (0.084 mol) of 2-amino-1 -methoxybutane and 20 ml of DMF was slowly added drop by drop and stirred at room temperature. The temperature of the mixture was raised to 155° C., and then the mixture was refluxed for 3 hours and cooled to room temperature. 60 ml of methanol was added to the reactant, and the product was precipitated and filtered. The filtered solid was recrystallized from a chloroform/ethanol solvent and dried in a vacuum to obtain 16.5 g of the compound (I) as a crystal with a light orange color (yield: 94%). The NMR spectrum of the obtained compound (I) is shown in FIG. 1.

### Preparation Example 2

### Preparation of Compound (II)

The following is a description of the preparation of the compound (II) having formula (3) below.

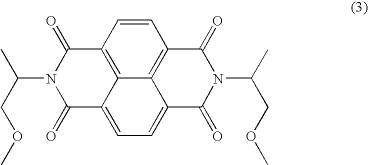

15.27 g of the compound (II) was obtained as a crystal with a light orange color in the same manner as in Preparation Example 1, except that 7.5 g (0.084 mol) of 2-amino-1-methoxypropane was used instead of 2-amino-1-methoxybutane (yield: 93%). The NMR spectrum of the obtained compound (II) is shown in FIG. 2.

### Example 1

4.5 parts by weight of the compound (I), 0.9 parts by weight of α-titanylphthalocyanine, 9 parts by weight of an enaminestilben-based hole transport material having formula (7) below, 15.9 parts by weight of a binder resin compound (O-PET, available from KANEBO), 84 parts by weight of methylene chloride, and 36 parts by weight of 1,1,2-trichloroethane were sand-milled for 2 hours and ultrasonically dispersed. The obtained solution was coated on an aluminum-PET sheet using a ring bar and dried at 110° C. for 1 hour to prepare an organophotoconductor drum having a thickness of about 10 to 12 μm.

### Example 2

An organophotoconductor drum was prepared in the same manner as in Example 1, except that 4.05 parts by weight of the compound (I) and 0.45 part by weight of diphenoquinone compound having formula (8) below were added as the electron transport material.

### Example 3

An organophotoconductor drum was prepared in the same manner as in Example 1, except that 4.5 parts by weight of the compound (II) was added as the electron transport material instead of the compound (I).

### Example 4

An organophotoconductor drum was prepared in the same manner as in Example 1, except that 4.05 parts by weight of the compound (II), and 0.45 part by weight of diphenoquinone compound having formula (8) below, were added as the electron transport material.

### Comparative Example 1

An organophotoconductor drum was prepared in the same manner as in Example 1, except that the compound (I) was not added, and only 13.5 parts by weight of the hole transport material having formula (7) below was added as the charge transport material.

### Comparative Example 2

An organophotoconductor drum was prepared in the same manner as in Example 1,. except that 4.05 parts by weight of the naphthalenetetradicarboxylic acid diimide derivative having formula (9) below was added instead of the compound (I).

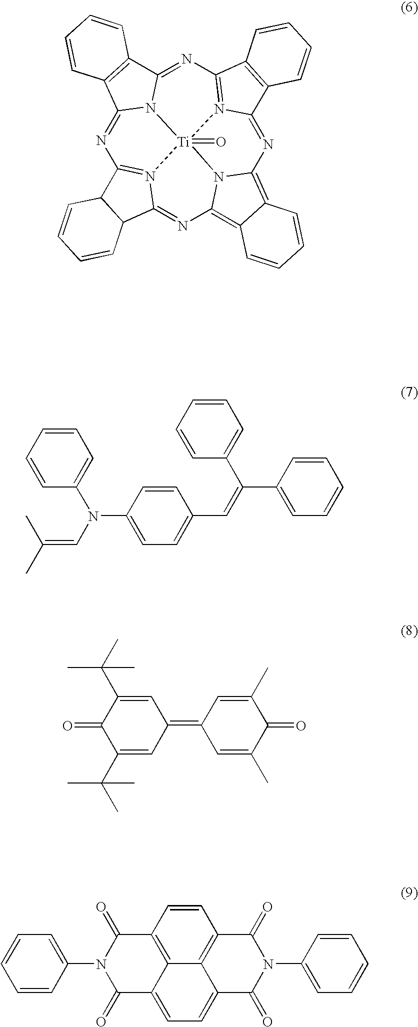

### Experimental Example

Electrophotographic characteristics of the respective electrophotographic organophotoconductor prepared in Examples 1 through 4 and Comparative Examples 1 and 2 were evaluated using a drum photoconductor evaluation apparatus (PDT-2000 manufactured by QEA). The initial charge and exposure potentials and the charge and exposure potentials after 300 cycles were measured.

The measured results are shown in Table 1.

TABLE 1

| | Vo initial | Vd initial | Vo 300 | Vd 300 |
|---|---|---|---|---|
| Example 1 | 643 | 79 | 635 | 81 |
| Example 2 | 641 | 81 | 640 | 80 |
| Example 3 | 652 | 81 | 645 | 84 |
| Example 4 | 648 | 82 | 650 | 81 |
| Comparative | 660 | 131 | 510 | 150 |
| Example 1 | | | | |
| Comparative | 650 | 101 | 589 | 113 |
| Example 2 | | | | |

Vo initial: initial charge potential
Vd initial: initial exposure potential
Vo 300: charge potential after 300 cycles
Vd 300: exposure potential after 300 cycles

As is apparent from Table 1, in the photoconductors prepared in Examples 1 to 4 that include the naphthalenetetracarboxylic diimide derivative according to an embodiment of the present invention, the charge potential values and the exposure potential values after 300 cycles are almost equal to the initial potential values and the initial exposure potential values. Meanwhile, in the photoconductors prepared in Comparative Examples 1 and 2, the charge potential values after 300 cycles are lower than the initial charge potential values and the exposure potential values after 300 cycles are higher than the initial exposure potential values.

Thus, the photoconductor containing the naphthalenetetracarboxylic diimide derivatives according to an embodiment of the present invention has better electrostatic properties than the electrostatic properties of the photoconductor that includes the conventional naphthalenetetracarboxylic acid derivative or titanylphthalocyanine as the electron transport materials. These results are obtained from that the compounds (I) and (II) prepared in the above Preparation Examples 1 and 2 have improved solubility in organic solvents such as methylene chloride and 1,1,2-trichloroethan, and improved compatibility with polyester binder resin.

As described above, the electrophotographic photoconductor that includes the naphthalenetetracarboxylic diimide derivative according to an embodiment of the present invention has improved solubility in organic solvents and an effective compatibility with polymer binder resins, thus providing effective electron transporting ability.

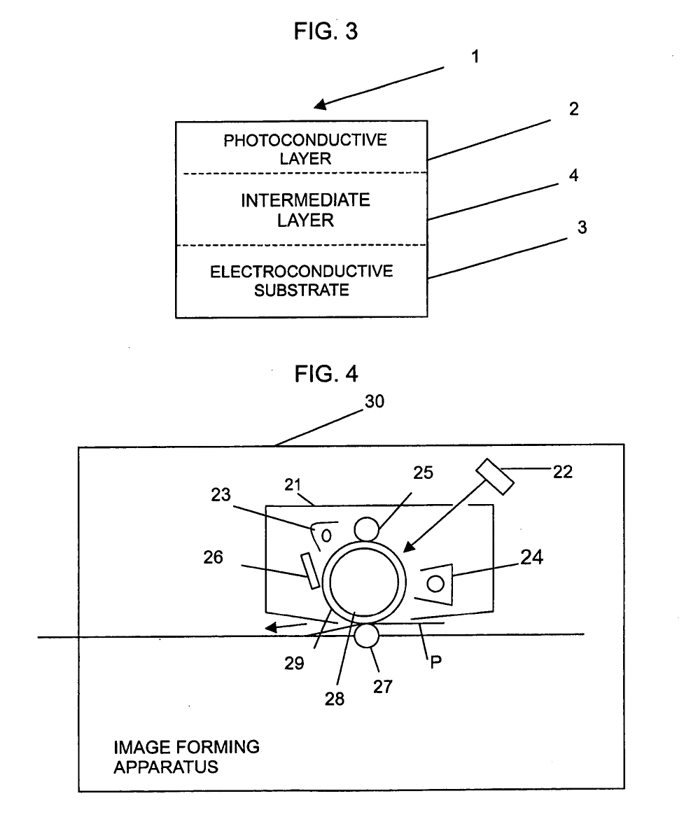

FIG. 3 is a block diagram illustrating (not to scale) an electrophotographic photoreceptor 1 comprising an electroconductive substrate 3 and a photoconductive layer 2, and where desired, an intermediate layer 4, in accordance with an embodiment of the present invention.

FIG. 4 is a schematic representation of an image forming apparatus 30, an electrophotgraphic drum 28, and an electrophographic cartridge 21 in accordance with selected embodiments of the present invention. The electrophotographic cartridge 21 typically comprises an electrophotographic photoreceptor 29 and at least one of a charging device 25 that charges the electrophotographic photoreceptor 29, a developing device 24 which develops an electrostatic latent image formed on the electrophotographic photoreceptor 29, and a cleaning device 26 which cleans a surface of the electrophotographic photoreceptor 29. The electrophotographic cartridge 21 may be attached to or detached from the image forming apparatus 30, and the electrophotographic photoreceptor 29 is described more fully above.

The electrophotographic photoreceptor drum 28, 29 for an image forming apparatus 30, generally includes a drum 28 that is attachable to and detachable from the electrophotographic apparatus 30 and that includes an electrophotographic photoreceptor 29 disposed on the drum 28, wherein the electrophotographic photoreceptor 29 is described more fully above.

Generally, the image forming apparatus 30 includes a photoreceptor unit (e.g., an electrophotographic photoreceptor drum 28, 29), a charging device 25 which charges the photoreceptor unit, an imagewise light irradiating device 22 which irradiates the charged photoreceptor unit with imagewise light to form an electrostatic latent image on the photoreceptor unit, a developing unit 24 that develops the electrostatic latent image with a toner to form a toner image on the photoreceptor unit, and a transfer device 27 which transfers the toner image onto a receiving material, such as paper P, wherein the photoreceptor unit comprises an electrophotographic photoreceptor 29 as described in greater detail above. The charging device 25 may be supplied with a voltage as a charging unit and may contact and charge the electrophotographic receptor. Where desired, the apparatus may include a pre-exposure unit 23 to erase residual charge on the surface of the electrophotographic photoreceptor to prepare for a next cycle.

The electrophotographic image forming apparatus 30 includes a plurality of support rollers 25, 27 (in the embodiment shown, the support rollers are the charging drive 25 and the transfer device 27). The electrophotographic photoreceptor 29 is operably coupled to the support rollers 25, 27 such that motion of the support rollers 25, 27 results in motion of the electrophotographic photoreceptor 29.

Where desired, the photoreceptor may have a protective layer disposed thereon (not shown).

Although a few embodiments of the present invention have been shown and described, it would be appreciated by those skilled in the art that changes may be made in these embodiments without departing from the principles and spirit of the invention, the scope of which is defined in the claims and their equivalents.

1. An electrophotographic photoconductor comprising:
an electroconductive substrate; and
a photoconductive layer formed on the electroconductive substrate, the photoconductive layer comprising a naphthalenetetracarboxylic diimide derivative having formula (1) below: 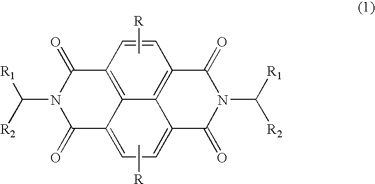
wherein R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12.

2. An electrophotographic photoconductor comprising:
an electroconductive substrate;
an intermediate layer formed on the electroconductive substrate; and
a photoconductive layer formed on the intermediate layer, the intermediate layer comprising a naphthalenetetracarboxylic diimide derivative having formula (1) below: 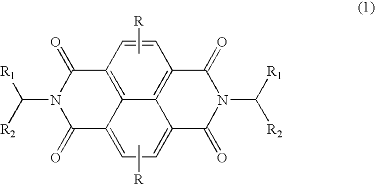
where R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12.

3. The electrophotographic photoconductor of claim 1, wherein R is a hydrogen atom, R₁ is one of methyl, ethyl, and propyl, and R₂ is one of methoxymethyl, methoxyethyl, and ethoxymethyl.

4. An electrophotographic image forming apparatus comprising:
a plurality of support rollers; and
a photoconductor operably coupled to the support rollers such that motion of the support rollers results in motion of the photoconductor,
the photoconductor having a photoconductive layer comprising a naphthalenetetracarboxylic diimide derivative having formula (1) below: 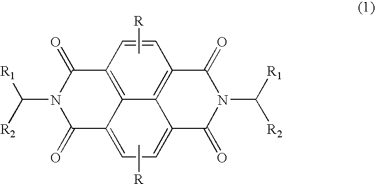
wherein R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12.

5. The electrophotographic image forming apparatus of claim 4, further comprising a liquid toner dispenser.

6. The electrophotographic photoconductor of claim 2, wherein R is a hydrogen atom, R₁ is one of methyl, ethyl, and propyl, and R₂ is one of methoxymethyl, methoxyethyl, and ethoxymethyl.

7. An electrophotographic cartridge comprising:
an electrophotographic photoreceptor comprising:
an electroconductive substrate;
a photoconductive layer formed on the electroconductive substrate, the photoconductive layer comprising a naphthalenetetracarboxylic diimide derivative having formula (1) below: 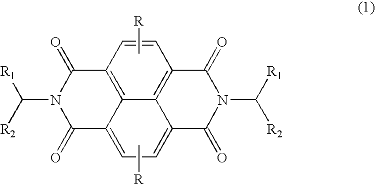
wherein R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group,and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12; and
n is an integer between 3 and 200; and
at least one of:
a charging device charging the electrophotographic photoreceptor;
a developing device developing an electrostatic latent image formed on the electrophotographic photoreceptor; and
a cleaning device cleaning a surface of the electrophotographic photoreceptor, the electrophotographic cartridge being attachable to or detachable from the image forming apparatus.

8. The electrophotographic cartridge of claim 7, wherein the photoreceptor is one of: a single-layered type and a laminated type.

9. An electrophotographic drum comprising:
a drum attachable to and detachable from an image forming apparatus; and
an electrophotographic photoreceptor disposed on the drum, the electrophotographic photoreceptor comprising:
an electroconductive substrate; and
a photoconductive layer formed on the electroconductive substrate, the photoconductive layer comprising a naphthalenetetracarboxylic diimide derivative having formula (1) below: 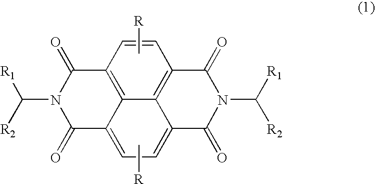
wherein R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12.

10. The electrophotographic drum of claim 9, wherein the photoreceptor is one of: a single-layered type and a laminated type.

11. An image forming apparatus comprising:
a photoreceptor unit comprising:
an electroconductive substrate;
a photoconductive layer formed on the electroconductive substrate, the photoconductive layer comprising a naphthalenetetracarboxylic diimide derivative having formula (1) below: 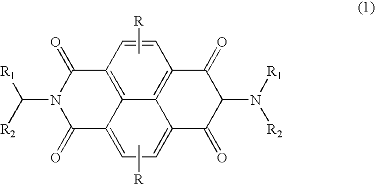
wherein R and R₁ are independently selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group;
R₂ is a group having the formula —(CH₂)ₙ—O—R₃, wherein
R₃ is selected from the group consisting of a hydrogen atom, a C₁-C₂₀ substituted or unsubstituted alkyl group, a C₁-C₂₀ substituted or unsubstituted alkoxy group, a C₆-C₃₀ substituted or unsubstituted aryl group, and a C₇-C₃₀ substituted or unsubstituted aralkyl group; and
n is an integer between 1 and 12;
a charging device which charges the photoreceptor unit;
an imagewise light irradiating device which irradiates the charged photoreceptor unit with imagewise light to form an electrostatic latent image on the photoreceptor unit;
a developing unit that develops the electrostatic latent image with a toner to form a toner image on the photoreceptor unit; and
a transfer device which transfers the toner image onto a receiving material.

12. The image forming apparatus of claim 11, wherein the photoreceptor is one of: a single-layered type and a laminated type.

13. The electrophotographic photoconductor of claim 1, wherein the photoconductive layer comprises a compound (I) of the formula (2) below:

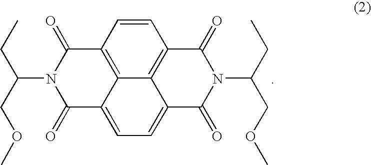

14. The electrophotographic photoreceptor of claim 2, wherein the photoconductive layer comprises a compound (I) of the formula (2) below:

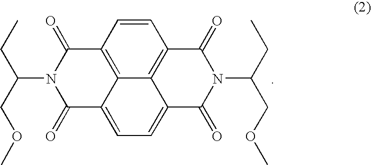

15. The electrophotographic image forming apparatus of claim 4, wherein the photoconductive layer comprises a compound (I) of the formula (2) below:

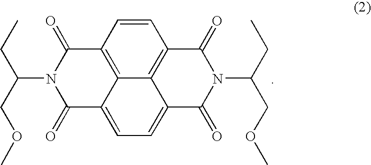

16. The electrophotographic cartridge of claim 7, wherein the photoconductive layer comprises a compound (I) of the formula (2) below:

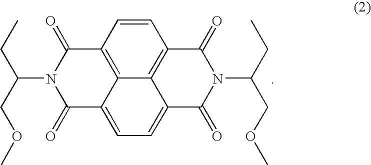

17. The electrophotographic drum of claim 9, wherein the photoconductive layer comprises a compound (I) of the formula (2) below:

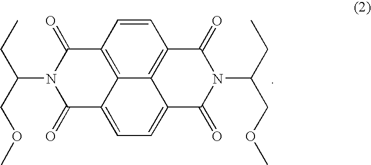

18. The image forming apparatus of claim 11, wherein the photoconductive layer comprises a compound (I) of the formula (2) below:

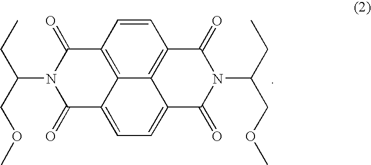

19. The electrophotographic photoreceptor of claim 2, wherein the photoconductive layer is approximately 5 to 50 μm thick.

20. The electrophotographic image forming apparatus of claim 4, wherein the photoconductive layer is approximately 5 to 50 μm thick.

21. The electrophotographic cartridge of claim 7, wherein the photoconductive layer is approximately 5 to 50 μm thick.

22. The electrophotographic drum of claim 9, wherein the photoconductive layer is approximately 5 to 50 μm thick.

23. The image forming apparatus of claim 11, wherein the photoconductive layer is approximately 5 to 50 μm thick.

24. The electrophotographic photoconductor of claim 1, wherein the photoconductive layer comprises a compound (II) of the formula (3) below:

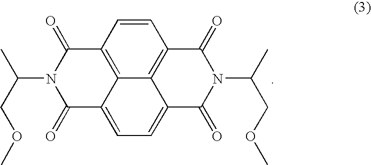

25. The electrophotographic photoreceptor of claim 2, wherein the photoconductive layer comprises a compound (II) of the formula (3) below:

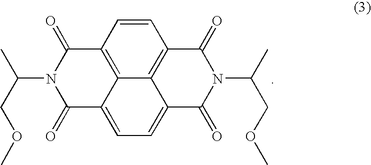

26. The electrophotographic image forming apparatus of claim 4, wherein the photoconductive layer comprises a compound (II) of the formula (3) below:

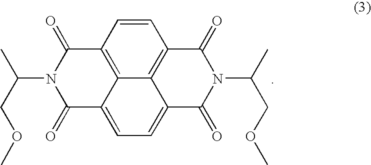

27. The electrophotographic cartridge of claim 7, wherein the photoconductive layer comprises a compound (II) of the formula (3) below:

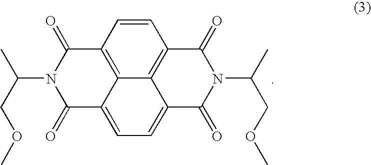

28. The electrophotographic drum of claim 9, wherein the photoconductive layer comprises a compound (II) of the formula (3) below:

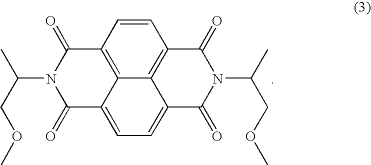

29. The image forming apparatus of claim 11, wherein the photoconductive layer comprises a compound (II) of the formula (3) below:

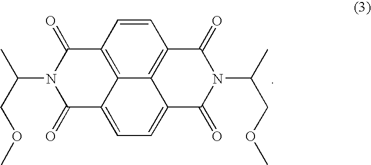

30. The electrophotographic drum of claim 9, wherein the photoconductive layer comprises approximately 4.5 parts by weight of compound (II), having formula (3) below, added as an electron transport material:

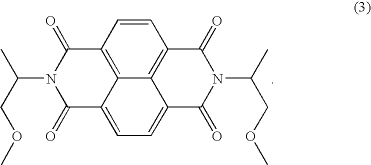

31. The electrophotographic drum of claim 9, wherein the photoconductive layer approximately 4.05 parts by weight of compound (II), having formula (3) below, and approximately 0.45 part by weight of diphenoquinone compound having formula (8) below, added as electron transport materials: [chemical structure]
